(19) United States
(12) Patent Application Publication
(10) Pub. No.: US 2007/0283612 A1
(43) Pub. Date: Dec. 13, 2007

(54) Lighted fishing rod

(75) Inventors: Terena Shaw, Ontario (CA); Richard Kris Nahrgang, Ontario (CA); Ting Dong Gou, Tianjin City (CN)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: FANCY FREE, LTD.

(21) Appl. No.: 11/449,441

(22) Filed: Jun. 8, 2006

(51) Int. Cl. A01K 97/12

(52) U.S. Cl. 43/17; 43/17.5

(57) ABSTRACT

A fishing rod provides a lighting system that includes a timer circuit and a motion responsive switch. In response to motion, the timer circuit activates lights to illuminate the fishing rod for a pre-determined interval. The circuit extinguishes the lights at the end of the interval. Preferably, the fishing rod is fabricated of a translucent material and the lights are LEDs housed within the core of the fishing rod.

### FIELD OF THE INVENTION

This invention relates to the field of fishing rods. In particular, this invention relates to the field of lighted fishing rods.

### BACKGROUND OF THE INVENTION

There has been a need in the field of fishing rods for rods that illuminate at night to facilitate night fishing or that illuminate in response to mechanical stimulus, such as a fish striking at bait, in order to notify the user. There has been much technological development in this field. For example, Dean (U.S. Pat. No. 2,575,049) discloses a fishing pole with an electrical system incorporated in the structure of the pole that provides a visual or audible signal to the user when the line is pulled. Fore (U.S. Pat. No. 3,017,499) describes an illuminated fishing rod with an electric light and battery in the hollow handle. Lamb (U.S. Pat. No. 3,238,659) describes a fishing rod with an illumination means incorporated within the rod activated by a master switch. Kaye (U.S. Pat. No. 3,882,629) describes a fishing light assembly comprising a tilt-switch controlling current from the battery to a light bulb.

Further, Ochs (U.S. Pat. No. 4,026,059) teaches a fishing rod with a transparent or translucent member allowing the projection of light along the length of the rod from the handle to the rod tip. McCulley (U.S. Pat. No. 4,458,438) describes a fish striker indicator that comprises a system that actuates a signal light and horn when the tip of the rod flexes beyond a predetermined amount. Echols, Jr. (U.S. Pat. No. 5,205,061) discloses a LED movement indicator system for a fishing rod that includes an on/off switch.

Moreover, Cota (U.S. Pat. No. 5,357,410) describes a lighted fishing pole system utilizing a mercury switch, light battery and three-position switch (for “off”, “on” and for when rod is jerked). Sparks (U.S. Pat. No. 5,738,433) teaches a lighted fishing rod that uses a hollow core or fibre optics to cause the rod to be illuminated along its length. An on/off switch is included in the system, which is integrated with the handle. Matibe (U.S. Pat. No. 5,826,366) discloses a system that uses neon gas to illuminate a fishing rod. Toelken (U.S. Pat. No. 6,061,946) describes a fishing rod with a lighted tip produced from clear or translucent plastic and containing an LED. Walker (U.S. Pat. No. 6,393,753) teaches a fishing rod audio alert system where the intensity of the audio element varies proportionally with the flexing of the rod.

Notably, Kneller (U.S. Pat. No. 6,789,348) teaches an illuminated two-piece fiber glass fishing rod having a LED or a light bulb proximate its tip encased in a hollow segment of the rod. The battery is encased in the handle. The hollow segment is connected to a butt segment, and these segments can be disassembled for portage. The segments are connected by ferrules. An on/off switch is located on the handle.

However, none of the prior art discloses a fishing rod having a timer feature wherein a light is activated upon fishing rod movement, and then deactivated after a timed interval. The purpose of the timed interval is to reduce the demand placed on the fishing rod's power source, such as a battery, since lights only become activated for specified intervals, resulting in an increase in battery life. This concept has been described in other applications for other purposes, namely for footwear, in U.S. Pat. No. 4,848,009 to Rodgers. Rodgers discloses a footwear lighting system comprising a battery and a light source and a motion responsive switch to intermittently connect the battery to the light source. A circuit is provided that extinguishes the light after a predetermined interval.

In addition to footwear, this technology has been applied in several different fields for several different applications, including: a fishing lure (U.S. Pat. Nos. 5,461,815 and 5,697,182, both to Rodgers), a snorkel and scuba device (U.S. Pat. No. 5,622,422 to Rodgers), a gear shift knob (U.S. Pat. No. 5,900,678 to Rodgers), a carrying bag (U.S. Pat. No. 6,158,872), a flying disc toy (U.S. Pat. No. 5,611,720 to Vandermaas) and a bowling ball (U.S. Pat. No. 6,280,344 to Robb). Most recently, a safety light for aquatic garments has been proposed in U.S. Patent Application Publication No. 2004/0150987, disclosing a circuit that times an interval in response to change of state of an acceleration switch.

There is a need therefore for a fishing rod apparatus that adapts the aforesaid circuit technology to provide a lighted fishing rod having the aforesaid features that is relatively easy to manufacture and to use.

### SUMMARY OF THE INVENTION

The present invention is a fishing rod that illuminates for a predetermined amount of time in response to mechanical stimulus such as a fish striking at bait suspended from the fishing rod's line.

In particular, the present invention includes a timing circuit that is operably connected to a battery, a motion responsive switch, and at least one light source, preferably a light-emitting diode (“LED”) and preferably a plurality of LEDs disposed along the length of the pole portion of the fishing rod. The timing circuit controls the connection between the battery and the LEDs. When the rod is motionless, the motion responsive switch remains in the open position, and no electrical power is provided to the LEDs. Upon movement of the rod (ideally as a result of having caught a fish), the motion responsive switch is closed, initiating a timed interval and providing power to activate the LEDs. The LEDs are deactivated at the end of the timed interval by the timing circuit. Therefore, as a result of the timing feature the LEDs cannot remain on for a continuous period but only for a timed interval, thereby prolonging the battery life.

Preferably, the battery, timing circuit, and motion response switch are housed within the fishing rod handle portion, with the circuit enclosed within the rod and provided throughout the length of the rod providing power to a plurality of LEDs. Enclosure of the circuitry and components integrally within the rod prevents contact with water.

The present invention provides for both “on” and “off” switches that override the motion responsive switch so that the light sources remain in activated or deactivated states, respectively. Preferably, there is a single manual switch with three settings: “off”, “ready” and “on”. The “ready” setting sets the rod to be responsive to motion.

Preferably, LEDs are disposed in the core of the pole portion of the fishing rod, which is translucent to allow the light to be visible from the exterior. Alternatively, an opaque pole portion can include holes or eyelets through which light from the LEDs is visible from the exterior. Although a plurality of LEDs is preferred, the present invention contemplates a variety of outputs, including other light sources such as fibre optic cables and electroluminescent strips, as well as auditory outputs, such as a combination of a speaker and a sound chip.

The present invention also provides for modularity, allowing assembly and disassembly of the fishing rod without disturbing the circuitry disposed in each segment of the rod providing power to the light sources disposed throughout the length of the rod.

Another aspect of the present invention is the inclusion of a photocell operably connected to the circuit to automatically turn the lighting system “off” and “on” in response to daytime/light and nighttime/dark conditions, respectively.

### BRIEF DESCRIPTION OF THE DRAWINGS

A detailed description of the preferred embodiment(s) is(are) provided herein below by way of example only and with reference to the following drawings, in which:

FIG. 1 illustrates a fishing rod in accordance with the present invention;

FIG. 2 illustrates a section of a handle portion of a fishing rod, housing components of the present invention;

FIG. 3 illustrates a ferrule joint for a modular fishing rod with electrical connection to extend the circuit to adjacent segments of the rod;

FIG. 4 illustrates the preferred embodiment for the circuitry of the present invention;

FIG. 5 illustrates a simple schematic of the circuitry of the preferred embodiment;

FIG. 6 illustrates a simple schematic of the circuitry of the present invention with an off switch for overriding the motion responsive switch;

FIG. 7 illustrates a simple schematic of the circuitry of the invention with an on switch for overriding the motion responsive switch; and

FIG. 8 illustrates a simple schematic of the circuitry of the invention with a manual two-way switch, operable for both an on and off setting for overriding the motion responsive switch.

In the figures, embodiments of the invention are illustrated by way of example. It is expressly understood that the description and drawings are only for the purpose of illustration and as an aid to understanding, and are not intended as a definition of the limits of the invention.

### DETAILED DESCRIPTION OF THE INVENTION

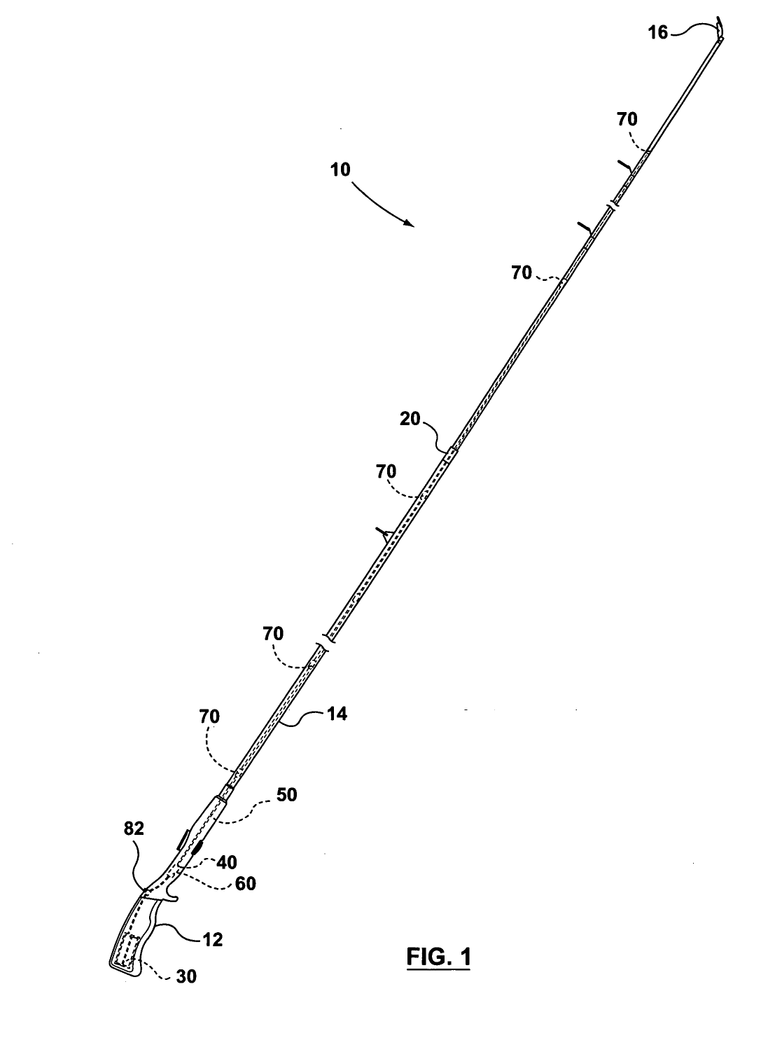

The preferred embodiment of the present invention is the fishing rod illustrated in FIG. 1. The fishing rod 10 consists of a handle portion 12 and a pole portion 14. The fishing rod 10 has a tip 16 and eyelets 18 disposed along its length. The system of the present invention is designed to fit within the handle of a fishing rod, which would be modified from the standard handles currently in the marketplace to allow the components to fit into a cavity, such that the on/off switch could be mounted to allow it to be manually activated or deactivated.

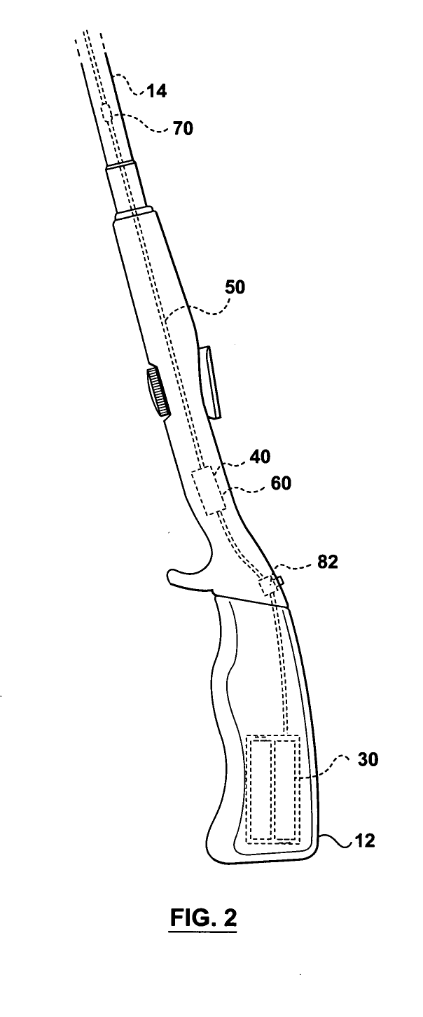

FIG. 2 illustrates the components of the present invention housed within the handle portion 12. The battery 30 is connected to the motion responsive switch 60 and the timer circuit 40. The timer circuit 40 is connected to the LEDs 70, disposed along the fishing rod 10 with circuit 50. The preferred embodiment includes an optional manual “off” switch 82, discussed below. It is not necessary for the various components to be located in the handle if the base of the rod is sufficiently large for the system to be housed in a cavity therein. However, the handle is the preferred location, in accordance with one particular embodiment of the present invention.

The circuit 50 and LEDs 70 are inserted in through the base of the fishing rod 10, and can be affixed to the inside of the rod cavity at various points between the handle portion 12 and tip 16. The fishing rod 10 itself is ideally fabricated of a translucent material which will allow the LEDs 70 to be seen from the exterior when illuminated. As an alternative to translucent material, the fishing rod 10 may be fabricated of an opaque material if openings or eyelets are provided so the LEDs 70 are visible on the exterior thereof.

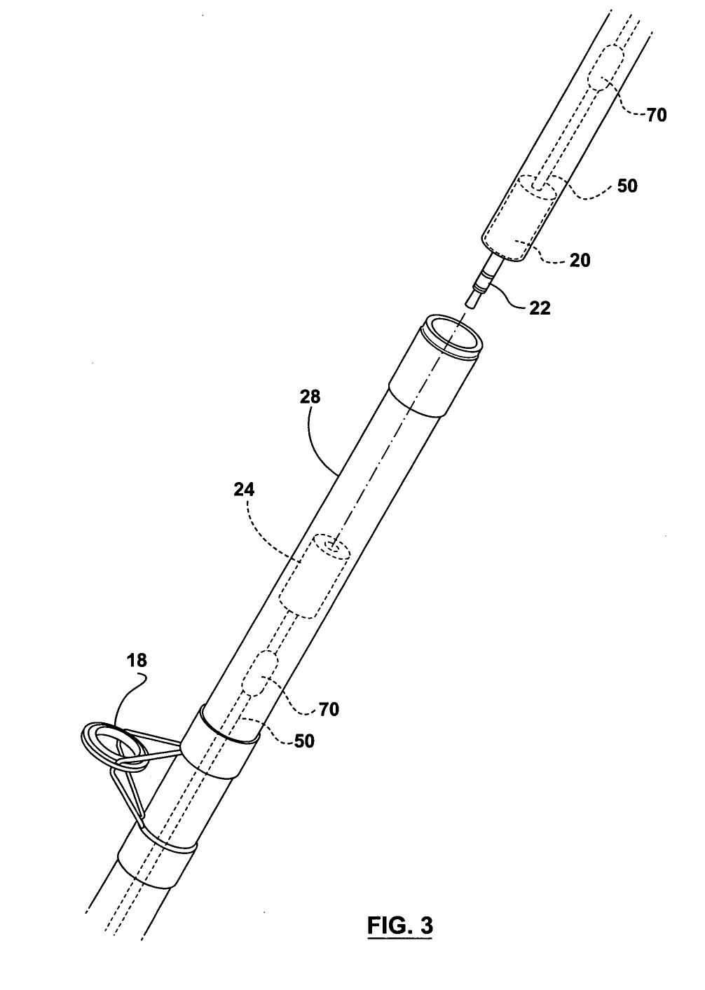

In the case of a modular or multi-section fishing rod, an electrical connection means can be provided at each ferrule joint, such as a simple male/female plug. This arrangement is depicted in FIG. 3. The fishing pole 10 has a ferrule joint 20 providing a connection to operably connect the lower segment 28 with the upper segment 26. The ferrule joint 20 comprises a conductive male connection 22 and a conductive female connection 24. The male connection 22 and female connection 24 connect the circuit 50 to provide power to LEDs 70 disposed in the lower segment 28 and upper segment 26 alike, thus allowing the light system to function along the entire length of the pole portion 14 of the fishing rod 10. Although the preferred embodiment comprises one joint and two rod segments, the present invention contemplates modular fishing rods having a plurality of ferrule joints corresponding to a plurality of rod segments.

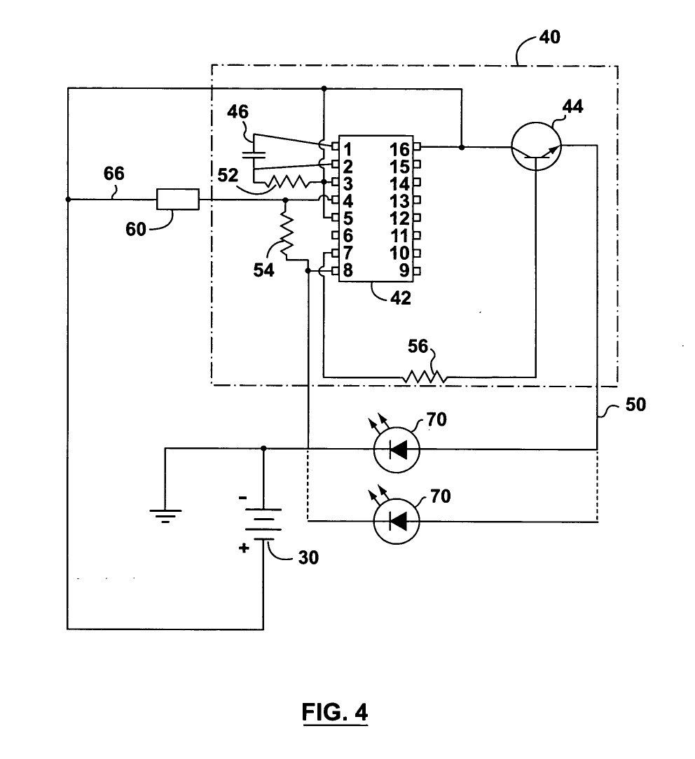

The circuitry of a preferred embodiment of the present invention is illustrated in FIG. 4, and U.S. Pat. No. 4,848,009 to Rodgers is incorporated herein by reference. In the diagram, a timer circuit 40 consists of an integrated circuit 42, a transistor 44, a capacitor 46, a resistor 1 52, a resistor 2 54 and a resistor 3 56. A power source such as a battery 30 is connected to activate the integrated circuit 42 at terminal 4. The positive terminal of the battery (usually 3 volts) is connected to the motion responsive switch 60 which is connected to the integrated circuit 42 at terminal 4. It is preferred that the motion responsive switch 60 is a spring switch such as one shown in U.S. Pat. No. 5,408,764 to Wut, or U.S. Pat. No. 5,599,088 to Chien. Other suitable motion responsive switches include a mercury switch or a rolling ball switch. If the motion responsive switch 60 closes when the battery 30 is connected, the battery 30 through the circuit line 66 causes terminal 4 of the integrated circuit 42 to go positive, and the resultant voltage change from 0-3 volts (or binary 0-1) at terminal 4 creates “SET” condition in the integrated circuit 42 which causes pin 7 to go negative. This transition creates conduction in the emitter-collector circuit of the transistor 44 which connects the battery 30 to the LEDs 70 through the power line 62. After a timed interval determined by the time constant of the capacitor 46 and resistor 1 52, the integrated circuit 42 is returned to “RESET” condition so that terminal 7 returns to a positive condition and stops conduction in the transistor 44 and thus turns off the LEDs 70. The LEDs 70 will remain off until there is a new negative to positive transition at terminal 4 of the integrated circuit 42. Note that resistor 2 54 and resistor 3 56 are part of the means for operating the circuit and are well known to those skilled in the art.

In an extended form of the circuitry above, the LEDs 70 may be replaced with an additional integrated circuit with LEDs. This additional integrated circuit may be programmed to produce a patterned flashing during the timed interval in accordance with the program in the circuit.

The preferred values for the circuitry of FIG. 4, in one particular implementation of the present invention, are as follows: INTEGRATED CIRCUIT #RR8503 MC 14528; TRANSISTOR #2N3906; CAPACITOR 0.47 uF at 30V; BATTERY 3 V; RESISTOR 1 1 MEGOHM 1/8 w; RESISTOR 2 1 MEGOHM 1/8 w; and RESISTOR 3 1 MEGOHM 1/8 w.

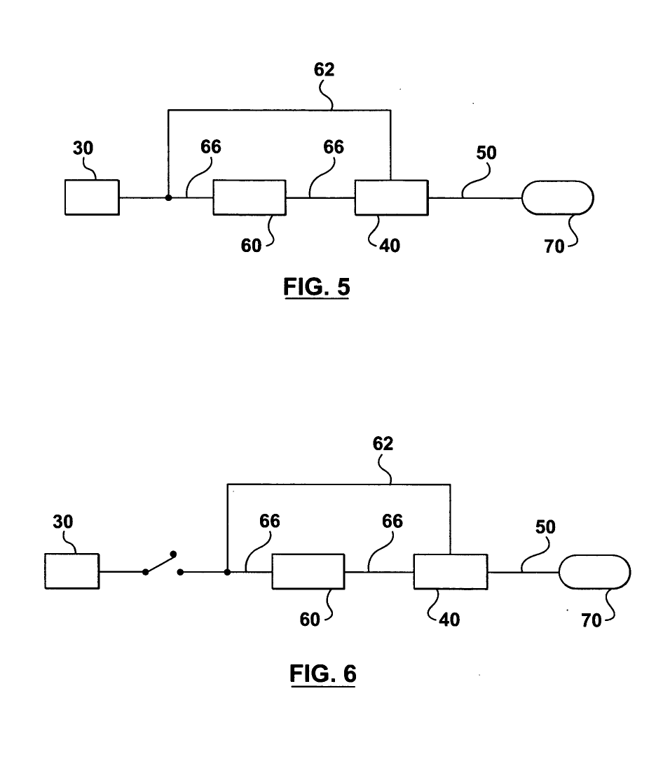

FIG. 5 is a simple schematic diagram further illustrating the preferred embodiment of the present invention.

In one aspect of the present invention, the fishing rod has a manual “off” switch which overrides the motion responsive switch so that the LEDs 70 do not turn on. This is illustrated in FIG. 6. A manual “off” switch 82 is connected in parallel with the battery 30 such that when the manual “off” switch 82 is open, there is no connection between the battery 30 and either the circuit line 66 or the power line 62, and therefore there is no source of power provided to the LEDs 70. This “off” switch feature is advantageous because it allows the user to keep the fishing rod system turned off during daytime conditions.

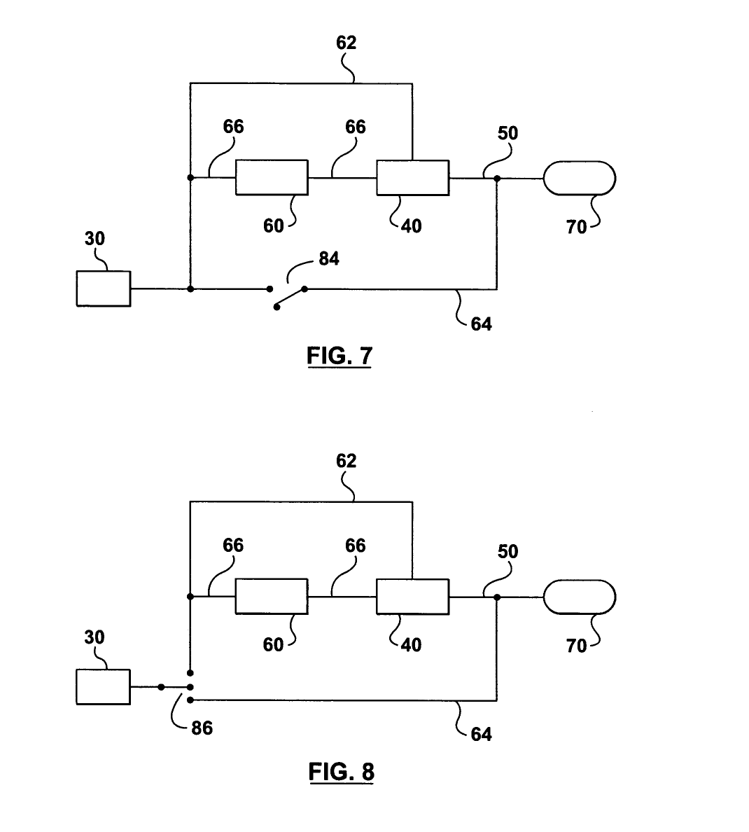

In another aspect of the present invention, the fishing rod has a manual “on” switch that overrides the motion responsive switch so that the rod maintains an illuminated state, whether there are any mechanical stimuli or not. This configuration is depicted in FIG. 7. There is a bypass line 64 having a manual “on” switch 84 connected between the battery 30 and the circuit 50, which is further connected to the LEDs 70. The bypass line 64 runs in parallel with the power line 62, such that when the manual “on” switch is open, the system is operable so that the LEDs 70 are connected to the battery 30 through the power line 62 for a timed interval initiated by the motion responsive switch 60, as taught by the present invention. However, when the manual “on” switch 84 is closed, the battery 30 is connected directly to the LEDs 70 directly via the bypass line 64, thus providing the continuous activation of the LEDs 70.

In yet another aspect of the present invention, the fishing rod has a manual switch with three settings: “off”, “ready” and “on”. In the first setting, the motion responsive switch is overridden so that the light remains off. In the second setting, the motion responsive switch is operable so that the light turns on in response to movement, in accordance with the description of the system described herein. In the third setting, the motion responsive switch is overridden so that the light remains on.

FIG. 8 depicts this configuration. There is a bypass line 64 having a two-way switch 86 operable to connect the battery 30 with the bypass line 64, or the battery 30 with the power line 62 and circuit line 66, or neither. When the two-way switch 86 is closed to connect the battery 30 with the power line 62 and circuit line 66, the LEDs are activated for timed interval initiated by the motion responsive switch 60, as taught by the present invention. When the two-way switch 86 is closed to connect the battery 30 with the bypass line 64, the LEDs 70 are continuously illuminated. When the two-way switch 86 is open, there is no connection between the battery 30 and the LEDs 70, and the LEDs 70 remain unilluminated.

In a further alternative embodiment of the present invention, the components (motion responsive switch, timing circuit, and battery) are housed within a fishing reel attached to the handle portion of the fishing rod, provided that the cavity within which it is located does not in any way interfere with the mechanism of the reel. In this case, the reel can be fabricated with conducting contact points on the base of a mounting platform for the reel, which platform is attached to the rod. The contact points can be operable so that the lights disposed along the rod would only function once the reel is attached to the rod handle. The rod handle would have a “hot shoe” which would accept the reel, such that the contacts would align with the conducting contacts on the rod thus completing the circuit.

Conversely, a set of lights and/or a speaker only could be mounted on or within a fishing reel, with the system components (motion responsive switch, timing circuit and battery) located within the handle portion of the fishing rod. The reel could also be fabricated with contact points, and the lights would only function once the reel is attached to a rod handle which has the full system base mounted within it. The “hot shoe” would accept the reel, such that the contacts on the reel would align with contacts in the rod handle thus completing the circuit.

There are many common motion responsive switches that can be used in the present invention, including spring switches, rolling ball switches, and mercury switches, although mercury switches are to be generally avoided because of the environmental implications of using them. The motion-responsive switch on the unit could be biased to the on or off positions. The present device has a further advantage being that where a mercury switch is used, the LEDs will not remain “on” if the angle of the switch causes the mercury therein to close the circuit. In such a case, the LEDs will become activated only when the mercury switch once again cycles from the disconnected state to the connected state.

Further, it should be clear that the present invention contemplates use of multicoloured LEDs or light bulbs and in this regard is not limited to monochromatic light. For example, an embodiment of the present invention can include a color-mixing LED composed of several light-emitting chips of different colors, used to generate light of various colours and intensities. An LED having these characteristics was disclosed in U.S. Pat. No. 6,764,193 to Wei in relation to a full-color shoe light device.

Although the preferred embodiment uses LEDs, the present invention provides that the output signal can both visual (using light sources such as LEDs, fibre optic cable or electroluminescent strips, or any combination thereof) and auditory, with for example a small wafer-style speaker and a sound chip. The sounds produced could be a simple chime or musical notes, to a more elaborate recorded message. Where a sound-emitting option is included, the speaker could be located in close proximity to the handle portion of the fishing rod, such that it is protected while allowing the sound to transmit clearly to the user.

It is preferable for the present invention that a battery is used as the source of electrical power. However, the present invention contemplates the use of solar power as a source of electricity, as well as some combination of battery and solar power technology. Further, the electric power source of the present invention may be a dynamo (or electric induction generator), a device that converts the energy of motion to that of an electric current. There are currently several devices on the market in the field of flashlights utilizing dynamos, some operating by a hand crank and others requiring shaking the flashlight.

The use of a photocell with the present invention is optional, and would be advantageous in automatically turning the system on or off depending on the external light conditions. In particular, the use of a photocell connected in series with motion responsive switch 60 is operable to prevent the LEDs 70 from illuminating when the fishing rod 10 is in daytime/light conditions.

What is claimed is:

1. A fishing rod comprising:
a pole portion;
a handle portion;
at least one light source;
an electrical power source for powering said light source;
a circuit;
a circuit timing means for timing an interval during which the at least one light source is activated; and
a motion responsive switch being responsive to movement of said pole portion to perform transitions between connected and disconnected states where the motion responsive switch respectively connects and disconnects said electrical power source to said circuit;
wherein the circuit, the motion responsive switch and the circuit timing means are linked together such that:
(a) when the motion responsive switch makes the transition from disconnected to connected states the circuit is operable to connect said electrical power source and said light source thereby causing said light source to activate; and
(b) after the duration of the interval the circuit is operable to disconnect said electrical power source and said light source thereby causing said light source to deactivate.

2. The fishing rod of claim 1 wherein said light source is disposed within the core of said pole portion, and said pole portion is operable to emanate light from the light source.

3. The fishing rod of claim 1 wherein said pole portion has a plurality of pole segments interconnectable one to the other by connection means, each connection means being operable to interconnect two adjacent rod segments, and having an electrically conductive portion thereof linked to the circuit to connect the circuit integrally within said pole portion.

4. The fishing rod of claim 1 having a manually operable off switch, operating in series with said motion responsive switch, used to connect and disconnect said electrical power source with said circuit, said manually operable off switch being operable to override said motion responsive switch so that said light source is not activated.

5. The fishing rod of claim 1 having a manually operable on switch, operating in parallel with said motion responsive switch, used to connect and disconnect said electrical power source with said circuit, said manually operable on switch being operable to override said motion responsive switch so that said light source is activated.

6. The fishing rod of claim 1 having a manually operable switch having three settings including:
a series switch, operating in series with said motion responsive switch, used to connect and disconnect said electrical power source with said circuit; and
a parallel switch, operating in parallel with said motion responsive switch, used to connect and disconnect said electrical power source with said circuit;
wherein said manually operable switch, series switch, parallel switch, circuit, electrical power source and motion responsive switch are linked together such that:
(a) in a first setting both said series switch and said parallel switch are open such that said electrical power source and said circuit are disconnected;
(b) in a second setting said series switch is closed and said parallel switch is open such that said electrical power source and said circuit are connected when the motion responsive switch makes the transition from disconnected to connected states; and
(c) in a third setting said parallel switch is closed such that the electrical power source and said circuit are connected.

7. The fishing rod of claim 1 having a photoelectric cell switch responsive to light conditions, operating in series with said motion responsive switch, used to connect and disconnect said electrical power source with said circuit for nighttime and daytime conditions, respectively, said photoelectric cell switch being operable to override said motion responsive switch so that said light source is not activated during nighttime light conditions.

8. The fishing rod of claim 1 wherein said electrical power source, said motion responsive switch and said circuit timing means are housed in said handle portion.

9. The fishing rod of claim 1 wherein said light source is housed in a fishing reel attached to said handle portion by reel connection means, said reel connection means having an electrically conductive portion thereof linked to the circuit to connect the said light source.

10. The fishing rod of claim 1 wherein said light source is a light-emitting diode.

11. The fishing rod of claim 10 wherein said light-emitting diode is multicoloured.

12. The fishing rod of claim 1 wherein said light source comprises fibre optics.

13. The fishing rod of claim 1 wherein said light source comprises electroluminescent strips.

14. The fishing rod of claim 1 wherein said electrical power source is a battery.

15. The fishing rod of claim 1 wherein said electrical power source is a battery and solar panel combination.

16. The fishing rod of claim 1 wherein said electrical power source is a manually powered dynamo.

17. The fishing rod of claim 1 wherein said motion responsive switch is a spring switch.

18. The fishing rod of claim 1 having an auditory indicator operating in parallel with the light source.

19. The fishing rod of claim 17 wherein the auditory indicator is a speaker located on the handle portion.

20. The fishing rod claim 9 having a speaker housed in said fishing reel operating in parallel with said light source.

21. A fishing reel comprising:
at least one light source;
an electrical power source for powering said light source;
a circuit;
a circuit timing means for timing an interval during which the at least one light source is activated; and
a motion responsive switch being responsive to movement to perform transitions between connected and disconnected states where the motion responsive switch respectively connects and disconnects said electrical power source to said circuit;
wherein the circuit, the motion responsive switch and the circuit timing means are linked together such that:
(a) when the motion responsive switch makes the transition from disconnected to connected states the circuit is operable to connect said electrical power source and said light source thereby causing said light source to activate; and
(b) after the duration of the interval the circuit is operable to disconnect said electrical power source and said light source thereby causing said light source to deactivate.
